(19) United States
(12) Patent Application Publication
(10) Pub. No.: US 2016/0134211 A1
(43) Pub. Date: May 12, 2016

(54) VENTILATEUR COMPORTANT UN DISPOSITIF DE TRANSFORMATION D'UN COURANT ELECTRIQUE TRIPHASE

(71) Applicant: TECHNOFAN, BLAGNAC (FR)

(72) Inventors: Pascal ROLLIN, DAUX (FR); Samuel BONNARD, LA SALVETAT SAINT GILLES (FR); Wenceslas BOURSE, BEAUZELLE (FR); Jacques VINCENT, TOULOUSE (FR)

(21) Appl. No.: 14/937,094

(22) Filed: Nov. 10, 2015

(30) Foreign Application Priority Data
Nov. 10, 2014 (FR) 1460854

(51) Int. Cl. H02P 6/00

(52) U.S. Cl. CPC H02P 6/002

(57) ABSTRACT

A fan, characterized in that the conversion device (59) is made up of three separate single-phase autotransformers (79a, 79b, 79c) that are magnetically uncoupled, each single-phase autotransformer (79a, 79b, 79c) being connected to one of the input terminals (70a, 70b, 70c) and at least one of the output terminals (71a₁, . . . , 71c₁, 71a₂, . . . , 71c₂), and being able to modify the voltage values of a single-phase input AC current coming from the corresponding input terminal to obtain a modified output current on the or each output terminal (71a₁, . . . , 71c₁, 71a₂, . . . , 71c₂) corresponding to that single-phase autotransformer (79a, 79b, 79c).

### FIELD OF THE INVENTION

The present invention relates to a fan including a rotary electric machine and a supply module able to connect the rotary electric machine to the power grid supplying a three-phase AC current. The supply module includes a conversion device able to adapt the three-phase AC current supplied by the power grid to the power supply of the rotary electric machine. The conversion device includes three input terminals connected to the electric supply grid and at least three output terminals connected to the rotary electric machine.

The fan according to the invention is in particular usable onboard an aircraft.

### BACKGROUND OF THE INVENTION

It is known in the state of the art to use onboard fans on various types of aircraft, in particular airplanes.

In general, certain types of onboard fans are used to cool different pieces of onboard equipment, for example onboard computers, or other types of devices equipping those aircraft. Other types of onboard fans for example contribute to recirculating cabin air.

To that end, such an onboard fan includes a rotary electric machine powered by an electric power grid of the aircraft and a fan wheel secured to the rotor of the rotary machine. The fan wheel is for example formed by a propeller and is positioned in an air duct emerging outside the aircraft.

It is also known to use onboard fans with a variable-frequency AC current supply.

Such a power supply type more particularly makes it possible to supply onboard fans with a high power, without depending on the stability of the electric power grid.

These fans are generally connected to the electric power grid providing a three-phase current, via a three-phase autotransformer rectifier. An autotransformer rectifier makes it possible to convert the three-phase electric grid into a DC grid while guaranteeing a suitable harmonic rejection of the grid.

The three-phase autotransformer generally includes the same magnetic circuit made from a ferromagnetic material for the three windings corresponding to the three phases. This carcass forms two “E”s across from one another. The three windings are each wound on a leg of these “E”s.

However, the fans including the conventional three-phase autotransformers are relatively cumbersome, their manufacture is relatively complicated and costly, and their performance is difficult to reproduce.

### SUMMARY OF THE INVENTION

The present invention aims to propose a fan including a device for converting a three-phase electric current able to replace the conventional autotransformer, the fan being compact, easy and inexpensive to manufacture, and having reproducible performance levels.

To that end, the invention relates to a fan of the aforementioned type, wherein the conversion device is made up of three separate single-phase autotransformers that are magnetically uncoupled, each single-phase autotransformer being connected to one of the input terminals and at least one of the output terminals, and being able to modify the voltage values of a single-phase input AC current coming from the corresponding input terminal to obtain a modified output current on the or each output terminal corresponding to that single-phase autotransformer.

The fan according to the invention may comprise one or more of the following features, considered alone or according to any technically possible combination:
the three single-phase autotransformers are substantially identical;
each single-phase autotransformer comprises a ferromagnetic core with a toroid shape, and a primary winding wound around at least part of the core and connected to the input terminal corresponding to this single-phase autotransformer;
the fan comprises first connecting means making it possible to connect the primary windings in a triangle;
the fan includes at least six output terminals and the fan is able to convert the three-phase AC current supplied by the electric power grid into six single-phase AC output currents, each single-phase AC output current supplying one of the output terminals;
each single-phase autotransformer further comprises two secondary windings wound around at least part of the core, each secondary winding being connected to one of the output terminals corresponding to this single-phase autotransformer;
the fan further comprises second connecting means making it possible to connect the secondary windings corresponding to a same single-phase autotransformer and the primary windings corresponding to the other two single-phase autotransformers;
the rotary electric machine is a three-phase machine;
the power module further includes a rectifier able to convert the three-phase AC current supplied by the conversion device into a DC current, and an inverter able to convert the DC current supplied by the rectifier into a three-phase current suitable for powering the rotary electric machine, the rectifier being connected between the conversion device and the inverter, the inverter being connected between the rectifier and the rotary electric machine;
the rotary electric machine includes a cylindrical outer wall;
the single-phase autotransformers are positioned around the outer wall of the rotary electric machine;
the single-phase autotransformers are spaced around the outer wall of the rotary electric machine, uniformly, and
the fan is usable in an aircraft.

### BRIEF DESCRIPTION OF THE DRAWINGS

The present invention will be better understood upon reading the following description, provided solely as an example and done in reference to the appended drawings, in which:

FIG. 1 is a diagrammatic view of an aircraft including a fan according to the invention;

FIG. 2 is a partially sectional diagrammatic view of the fan of FIG. 1, the fan including a power module;

FIG. 3 is a cross-section of the fan of FIG. 2 along line III-III′;

FIG. 4 is an electric diagram of the power module of FIG. 2, the power module including a conversion device; and

FIG. 5 is a diagrammatic view of the conversion device of FIG. 4.

### DETAILED DESCRIPTION OF THE INVENTION

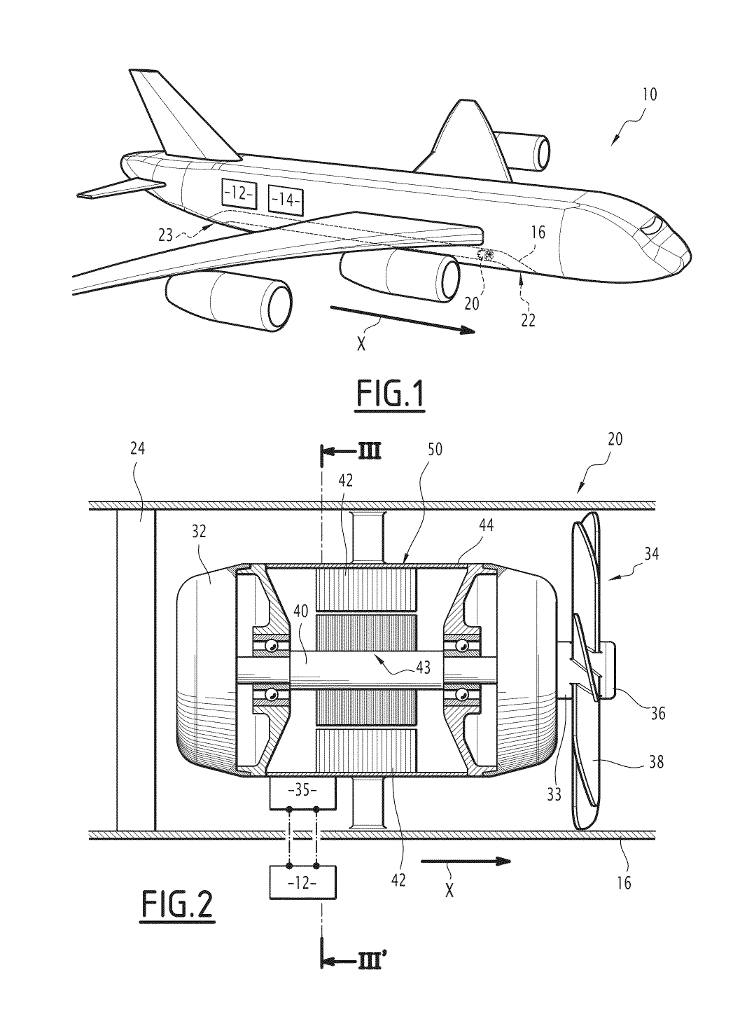

The aircraft 10 of FIG. 1 includes an electric power grid 12, onboard equipment 14, an air duct 16 emerging outside the aircraft 10, and a fan 20 according to the invention positioned in the air duct 16 and able to create a flow of air in the duct 16.

The aircraft 10 is for example an airliner.

The electric grid 12 is a high-voltage electric grid able to provide three-phase AC current with a voltage substantially equal to 115 V or 230 V and an intensity substantially equal to 30 A. The AC currents supplied by each phase of the electric power grid 12 are spaced apart by substantially 120°.

The electric grid 12 comprises at least three connecting terminals making it possible to connect the fan 20 to each phase.

The onboard equipment 14 comprises all equipment of the aircraft 10 whereof cooling is necessary during at least certain operating phases of the aircraft 10. One example of such equipment is an onboard computer, or part of such a computer, for example a computing core.

The air duct 16 is suitable for allowing the circulation of air in its inner part.

In FIG. 1, the air duct 16 extends substantially along a longitudinal movement axis X of the aircraft 10.

The air duct 16 includes an air inlet 22 positioned in the front part of the aircraft 10, an air outlet 23 positioned in the rear part of the aircraft 10, and a cylindrical segment in which a heat exchanger 24 is positioned transversely.

The air inlet 22 and the air outlet 23 are suitable for allowing the circulation of a flow of air in the inner part of the duct 16.

The heat exchanger 24, visible in FIG. 2, is thermally connected to the onboard equipment 14 and makes it possible to cool this equipment 14 when it is exposed to a flow of air circulating in the air duct 16.

The fan 20 is illustrated in more detail in FIG. 2.

According to this FIG. 2, the fan 20 includes a rotary electric machine 32 positioned in the cylindrical segment of the air duct 16 and having a rotary shaft 33, a fan wheel 34 secured to the rotary shaft 33, and a power module 35 able to connect the rotary electric machine 32 to the power grid 12.

The fan wheel 34 includes a hub 36 of revolution. The hub 36 bears a set of blades 38, the free end of which substantially follows the profile of the inner surface of the cylindrical segment of the air duct 16.

The fan wheel 34 is for example a propeller.

The rotary electric machine 32 is a synchronous three-phase electric machine known in itself.

The rotary electric machine 32 includes a rotor 40 and a stator 42.

The rotor 40 has a generally cylindrical shape. The rotor 40 is mounted rotating relative to the stator 42 and secured to the rotary shaft 33. The rotor 40 has a cylindrical outer surface comprising a set of magnetic elements 43, as well as magnetized bars.

The stator 42 extends around the rotor 40. The stator 42 has a cylindrical case 44 forming an outer wall and an inner wall of the rotary electric machine 32.

The case 44 houses an active part 50 of the stator 42, which is fixed on the inner wall of the rotary electric machine 32.

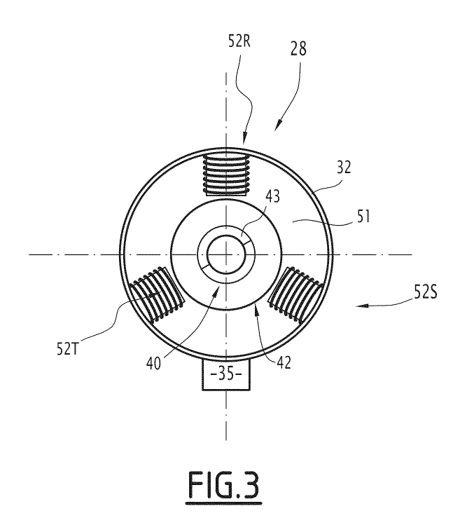

In reference to FIG. 3, the active part 50 of the stator 42 forms a cylindrical ring 51 and includes three sets 52R, 52S, 52T of windings on the inner surface of that ring 51. Each set of windings 52R, 52S, 52T is powered by a phase where a trapezoidal or sinusoidal current circulates.

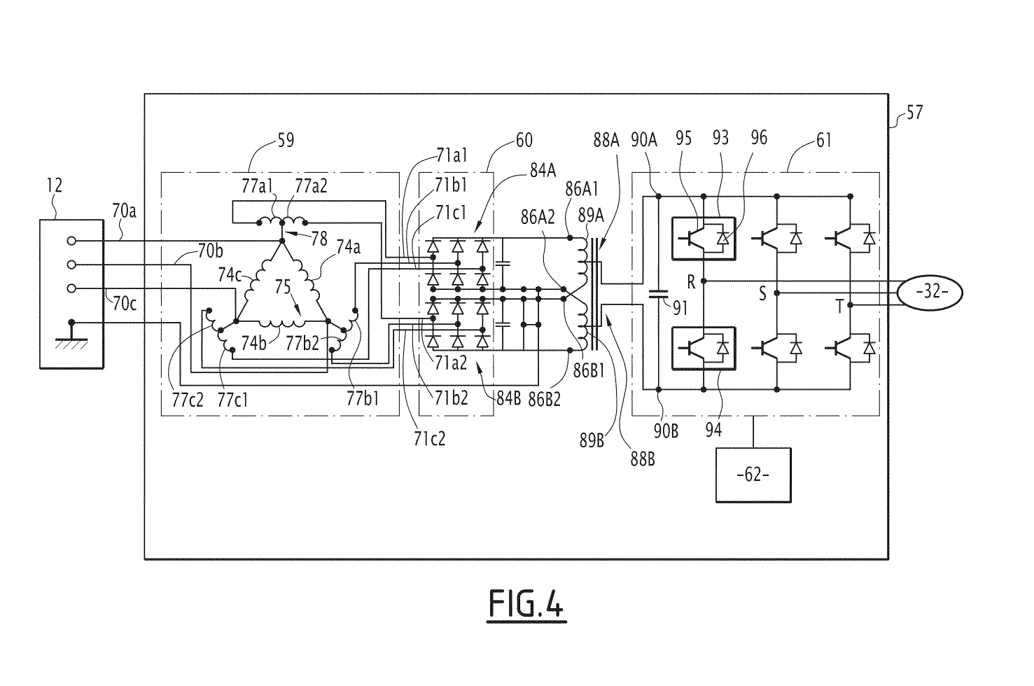

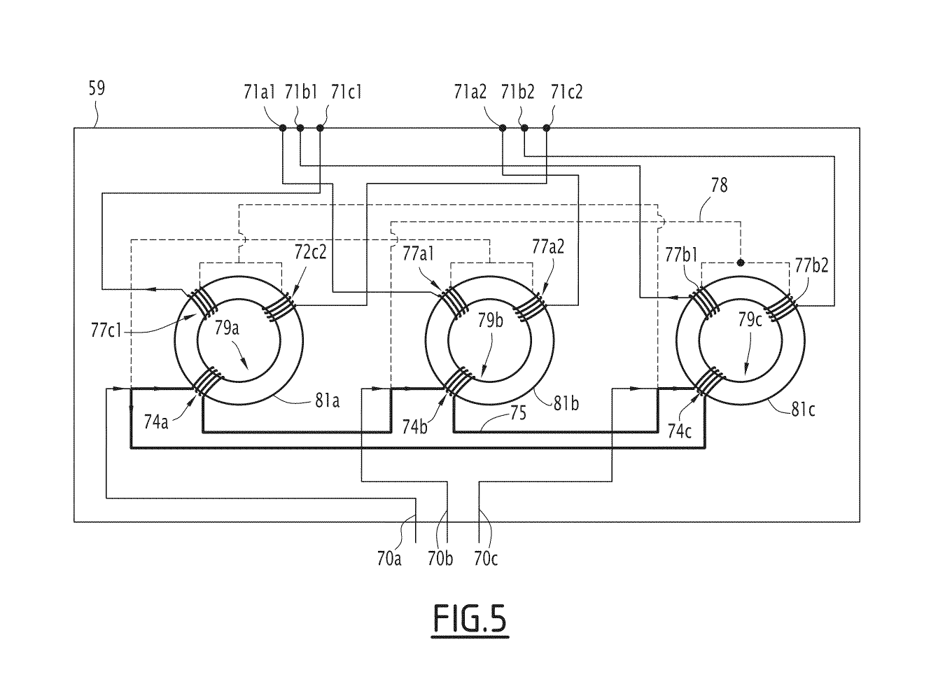

In reference to FIG. 4, the power module 35 comprises a conversion device 59 capable of modifying the voltage and/or intensity and/or phase values of the three-phase AC current supplied by the power grid 12, a rectifier 60 able to convert the three-phase AC current supplied by the conversion device 59 into a DC current, an inverter 61 able to convert the DC current supplied by the rectifier 60 into a three-phase AC current suitable for supplying the rotary electric machine 32, and a unit 62 for piloting the inverter 61.

The conversion device 59 is further able to convert the three-phase AC current supplied by the power grid 12 into two three-phase AC grids with a phase shift of 30° relative to one another. In other words, the conversion device 59 makes it possible to convert the three-phase AC current of the grid 12 into six single-phase AC output currents, each single-phase AC output current corresponding to an output phase of the conversion device 59.

To that end, the conversion device 59 includes three input terminals 70a, 70b, 70c each connected to a terminal of the power grid 12 and six output terminals 71a₁, 71a₂, 71b₁, 71b₂, 71c₁, 71c₂ connected to the rectifier 60.

The single-phase AC output currents supplied by the terminals 71a₁, 71b₁, 71c₁, and the single-phase AC output currents supplied by the terminals 71a₂, 71b₂, 71c₂ are for example phase shifted relative to one another by 30° .

The conversion device 59 includes three primary windings 74a, 74b, 74c connected to one another in a triangle by the first connecting means 75.

For each primary winding 74a, 74b, 74c, the conversion device 59 includes two secondary windings 77c₁, 77c₂, 77a₁, 77a₂, 77b₁, 77b₂.

The secondary windings 77c₁, 77c₂ are magnetically coupled with the primary windings 74a and are connected on the one hand to the other two primary windings 74b, 74c to second connecting means 78, and on the other hand to the output terminals 71c₁, 71c₂.

The secondary windings 77a₁, 77a₂ are magnetically coupled with the primary winding 74b and are connected on the one hand to the other two primary windings 74a, 74c by the second connecting means 78, and on the other hand to the output terminals 71a₁, 71a₂.

Lastly, the secondary windings 77b₁, 77b₂ are magnetically coupled with the primary winding 74c and are connected on the one hand to the other two primary windings 74a, 74b by the second connecting means 78, and on the other hand to the output terminals 71b₁, 71b₂.

According to the invention, the conversion device 59 is made up of three separate single-phase autotransformers 79a, 79b, 79c, diagrammatically shown in FIG. 5.

The three autotransformers 79a, 79b, 79c are for example substantially identical and are magnetically uncoupled on a magnetic circuit with no physical air gap.

Each transformer 79a, 79b, 79c is connected to an input terminal 70a, 70b, 70c, and to two output terminals 71a₁, 71a₂, 71b₁, 71b₂, 71c₁, 71c₂.

Each autotransformer 79a, 79b, 79c is able to modify the voltage and/or intensity values and phase of the single-phase AC current from the corresponding input terminal 70a, 70b, 70c.

According to FIG. 5, each autotransformer 79a, 79b, 79c comprises a toroid-shaped ferromagnetic core 81a, 81b, 81c that is specific to it.

The primary winding 74a and the secondary windings 77c₁, 77c₂ are wound on the core 81a of the autotransformer 79a and are angularly spaced apart from one another by air gaps.

The primary windings 74b and the secondary windings 77a₁, 77a₂ are wound on the core 81b of the autotransformer 79b and are angularly spaced apart from one another by air gaps.

The primary windings 74c and the secondary windings 77b₁, 77b₂ are wound on the core 81c of the autotransformer 79c and are angularly spaced apart from one another by air gaps.

Alternatively or additionally, at least some of the primary and secondary windings are wound on one another.

In FIG. 5, the first connecting means 75 are shown by a bold solid line, the second connecting means 78 by a thin broken line, and the other connecting means by a thin continuous line.

The single-phase autotransformers 79a, 79b, 79c are positioned in the power module 35 separately to improve the form factor of the fan 20. Thus, for example, the single-phase autotransformers 79a, 79b, 79c are positioned around the outer wall of the rotary electric machine 32.

According to FIG. 4, the rectifier 60 includes two rectifier bridges 84A, 84B connected in parallel to the conversion device 59.

More particularly, the rectifier bridge 84A is connected to the three output phases corresponding to the output terminals 71a₁, 71b₁, 71c₁ of the conversion device 59 and the rectifier bridge 85A is connected to the three output phases corresponding to the output terminals 71a₂, 71b₂, 71c₂ of the conversion device 59.

Each rectifier bridge 84A, 84B includes a pair of diodes for each output phase making it possible to rectify that phase.

Each rectifier bridge 84A, 84B further includes two outputs 86A₁, 86A₂ and 86B₁, 86B₂ each delivering a rectified current.

The outputs 86A₁, 86A₂, 86B₁, 86B₂ are combined by two interface induction coils 88A, 88B each including a coil 89A, 89B.

The coil 89A is connected to the outputs 86A₁ and 86B₁ and the coil 89B is connected to the outputs 86A₂ and 86B₂.

The interphase induction coils 88A, 88B thus connected make it possible to average the current delivered by each pair of outputs 86A₁, 86A₂, 86B₁, 86B₂ of the two rectifier bridges 84A, 84B to supply a DC current to the inverter 61.

The inverter 61 includes three switching branches corresponding to the three phases R, S, T of the rotary electric machine 32. These three branches are mounted in parallel between input terminals 90A and 90B of the inverter 61.

The inverter 61 further includes a capacitor 91 mounted in parallel with the three switching branches.

Each branch includes two switches 93, 94 mounted in series and between which a point R, S, T is formed for the three-phase supply of the rotary electric machine 32. Each switch includes a transistor 95 and a diode 96 mounted in parallel.

Each transistor 95 includes a gate connected to the control unit 62 via a control circuit to switch this transistor 95 between an open position and a closed position. In the closed position, the transistor 95 of each switch 93, 94 is able to allow a current to pass respectively from the terminal 90A to one of the terminals with phases R, S, T, or from one of the terminals of phases R, S, T toward the terminal 90B. In the open position, the transistor 95 does not allow any current to pass.

Each transistor 95 is for example an insulated gate bipolar transistor, such as an IGBT transistor known in itself.

The diode 96 of each switch 93, 94 is able to allow a current to pass respectively from the terminal 90B toward one of the terminals of the phases R, S, T, or from one of the terminals of the phases R, S, T toward the terminal 90A. When the transistors 95 are all open, the diodes 96 form a rectifier bridge.

The inverter 61 is for example a pulse width modulation inverter.

The control unit 62 is connected to the inverter 61 via the control circuit and makes it possible to control the operation of the inverter 61.

The operation of the fan 20 will now be explained.

Initially, the fan 20 is disconnected from the power grid 12.

When it is necessary to cool the onboard equipment 14, the fan 20 is connected to the power grid 12.

A three-phase electric current from the power grid 12 is first converted by the conversion device 59. In particular, each of the three autotransformers 79a, 79b, 79c converts the single-phase AC current supplied by the corresponding phase into two single-phase AC currents with different voltages or phases from the original ones.

Then, the currents modified by the conversion device 59 are converted into a DC current by the rectifier 60.

Lastly, the inverter 61 receives the DC current and converts it into a three-phase AC current suitable for powering the rotary electric machine 32, and in particular, the stator 42.

The stator creates a magnetic field driving the rotation of the rotor 40 and, consequently, the fan wheel 34.

One can then see that the present invention includes a certain number of advantages.

More particularly, the manufacture of the conversion device 59 made up of three separate single-phase autotransformers 79a, 79b, 79c is simpler and less expensive than that of a three-phase autotransformer traditionally used in the state of the art.

Indeed, the winding method for a single-phase autotransformer 79a, 79b, 79c can be done completely automatically. The requirements on the winding of a single-phase autotransformer 79a, 79b, 79c are lower than those of a three-phase autotransformer. This in particular makes it possible to better control the time, manufacturing costs and performance reproducibility.

Furthermore, the absence of an air gap in a single-phase autotransformer 79a, 79b, 79c compared to a three-phase autotransformer makes it possible to control a magnetic current in the windings 74a, 74b, 74c, 77a₁, 77a₂, 77b₁, 77b₂, 77c₁, 77c₂ during the design and/or exploitation of the conversion device 59.

Lastly, the conversion device 59 according to the invention is optimized to be integrated into a tubular form. Indeed, the possibility of physically separating the cores 81a, 81b, 81c from the single-phase autotransformer 79a, 79b, 79c makes it possible to better distribute these autotransformers, taking into account the form effect of the electric apparatus for which the conversion device 59 is used, for example a rotary electric machine 32 having a cylindrical shape. This also makes it possible to make the onboard fans including such an electric machine 32 and such a conversion device 59 more compact and better suited to heat dissipation.

1-12. (canceled)

13. A fan including a rotary electric machine and a supply module able to connect the rotary electric machine to a power grid supplying a three-phase AC current;
the supply module including a conversion device able to adapt the three-phase AC current supplied by the power grid to the power supply of the rotary electric machine ;
the conversion device includes three input terminals connected to the electric supply grid and at least three output terminals connected to the rotary electric machine ;
wherein the conversion device is made up of three separate single-phase autotransformers that are magnetically uncoupled, each single-phase autotransformer being connected to one of the input terminals and at least one of the output terminals, and being able to modify the voltage values of a single-phase input AC current coming from the corresponding input terminal to obtain a modified output current on the or each output terminal corresponding to that single-phase autotransformer.

14. The fan according to claim 13, wherein the three single-phase autotransformers are substantially identical.

15. The fan according to claim 13, wherein each single-phase autotransformer comprises a ferromagnetic core with a toroid shape, and a primary winding wound around at least part of the core and connected to the input terminal corresponding to this single-phase autotransformer.

16. The fan according to claim 15, further comprising first connecting means making it possible to connect the primary windings in a triangle.

17. The fan according to claim 15, further including at least six output terminals, the fan being able to convert the three-phase AC current supplied by the electric power grid into six single-phase AC output currents, each single-phase AC output current supplying one of the output terminals.

18. The fan according to claim 17, wherein each single-phase autotransformer further comprises two secondary windings wound around at least part of the core, each secondary winding being connected to one of the output terminals corresponding to this single-phase autotransformer.

19. The fan according to claim 18, further comprising second connecting means making it possible to connect the secondary windings corresponding to a same single-phase autotransformer and the primary windings corresponding to the other two single-phase autotransformers.

20. The fan according to claim 13, wherein the rotary electric machine is a three-phase machine.

21. The fan according to claim 20, wherein the power module further includes a rectifier able to convert the three-phase AC current supplied by the conversion device into a DC current, and an inverter able to convert the DC current supplied by the rectifier into a three-phase current suitable for powering the rotary electric machine;
the rectifier being connected between the conversion device and the inverter, the inverter being connected between the rectifier and the rotary electric machine.

22. The fan according to claim 13, wherein:
the rotary electric machine includes a cylindrical outer wall; and
the single-phase autotransformers are positioned around the outer wall of the rotary electric machine.

23. The fan according to claim 23, wherein the single-phase autotransformers are uniformly spaced around the outer wall of the rotary electric machine.

24. The fan according to claim 13, further including at least six output terminals, the fan being able to convert the three-phase AC current supplied by the electric power grid into six single-phase AC output currents, each single-phase AC output current supplying one of the output terminals.
